(19) United States
(12) Patent Application Publication
(10) Pub. No.: US 2007/0061264 A1
(43) Pub. Date: Mar. 15, 2007

(54) System and method for secure inter-domain document transmission

(75) Inventors: Michael Yeung, Mission Viejo, CA (US); Sameer Yami, Irvine, CA (US); Amir Shahindoust, Laguna Niguel, CA (US)

Correspondence Address: TUCKER, ELLIS & WEST LLP, 1150 HUNTINGTON BUILDING, 925 EUCLID AVENUE, CLEVELAND, OH, 44115-1414, US

(73) Assignees: Kabushiki Kaisha Toshiba; Toshiba Tec Kabushiki Kaisha, Tokyo (JP)

(21) Appl. No.: 11/227,510

(22) Filed: Sep. 15, 2005

(51) Int. Cl. H04L 9/00

(52) U.S. Cl. 705/51

(57) ABSTRACT

The present invention is directed to a system and method for secure inter-domain document transmission. Encrypted electronic document data is received from a source domain into a target domain. The encrypted electronic document includes header data containing encrypted user authentication data and data representing an identified file server associated with the target domain. Next, key data is retrieved from the identified file server. Decryption of the encrypted electronic document is then commenced using the retrieved key data.

### BACKGROUND OF THE INVENTION

This invention is directed to a method and system for the secure inter-domain transmission of an electronic document. More particularly, this invention is directed to a method and system for securely transmitting electronic document data across domains.

In conventional office settings, document processing devices, such as printers, copiers, facsimile machines, scanners, and the like, include little to no inherent data security. Thus, a user with physical access to the network on which the document processing devices are connected is able to view or intercept the plain text transmissions of documents from another user to one of the document processing devices with very little difficulty. Various attempts to encrypt document data have been employed, such as requiring the input of a password at the receiving document processing device to output the document. In typical secure document processing operations, a user encrypts a document for transmission to a document processing device. Once received, the document processing device decrypts the data and outputs the document accordingly. However, to maintain security, each document processing device on a computer network employs a unique public key/private key encryption combination. Such techniques are easily implemented on a single domain, however when transmitting across domains, decryption becomes problematic as the receiving device on the receiving domain lacks the necessary user authentication information to which a receiving device on the sending domain generally has access. Thus, a user cannot transmit an encrypted electronic document from one domain to another without also sending unencrypted authentication information to the document processing device.

The subject invention overcomes the aforementioned problems and provides a method and system for the secure inter-domain transmission of an electronic document.

### SUMMARY OF THE INVENTION

In accordance with the present invention, there is provided a system and method for the secure inter-domain transmission of an electronic document.

Further in accordance with the present invention, there is provided a system and method for the recovery of user related data given an encrypted file in a predetermined format.

Still further, in accordance with the present invention, there is provided a system and method for storing user specific authentication information on a trusted server in one domain, thereby enabling an electronic document to be accessed on another domain.

In accordance with the present invention, there is provided a system for secure inter-domain document transmission. The system includes receiving means adapted to receive an encrypted electronic document containing header data from a source domain into a target domain. Preferably, the header data includes data representing an identified file server associated with the target domain. The system also includes retrieving means adapted to retrieve key data from the identified file server. The system further includes commencement means adapted to commence the decryption of the encrypted electronic document using the key data retrieved from the identified file server.

In one embodiment, the system further includes receiving means adapted to receive the encrypted electronic document into a data storage associated with a document processor. The system of this embodiment also includes receiving means suitably adapted to receive the key data into the data storage and completion means adapted to complete the decryption of the electronic document. In addition, the system of this embodiment includes storing means adapted to store the decrypted electronic document in the data storage and commencement means adapted to commence a selected document processing operation on the decrypted electronic document.

Further, in accordance with the present invention, there is provided a method for secure inter-domain document transmission. The method begins by receiving an encrypted electronic document from a source domain into a target domain. The encrypted electronic document includes header data containing data representing an identified file server associated with the target domain. Next, key data is retrieved from the identified file server. Decryption of the encrypted electronic document is then commenced using the retrieved key data.

In one embodiment, the method also includes receiving the encrypted electronic document into a data storage associated with a document processor. The key data is then received into the data storage. Decryption of the encrypted electronic document is then completed, following which the decrypted electronic document is stored in the data storage. This particular embodiment further includes the step of commencing a selected document processing operation on the decrypted electronic document.

Still other advantages, aspects and features of the present invention will become readily apparent to those skilled in the art from the following description wherein there is shown and described a preferred embodiment of this invention, simply by way of illustration of one of the best modes best suited for to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

The subject invention is described with reference to certain parts, and arrangements to parts, which are evidenced in conjunction with the associated drawings, which form a part hereof and not, for the purposes of limiting the same in which:

FIG. 1 is a block diagram illustrative of the system of the present invention;

FIG. 2 is a flowchart illustrating a secure transmission method according to the present invention;

FIG. 3 is a flowchart illustrating a secure transmission method according to the present invention.

### DETAILED DESCRIPTION OF THE PREFERRED EMBODIMENT

This invention is directed to a system and method for secure inter-domain document transmission. In particular, the present invention is directed to a system and method for storing user specific authentication information on a trusted server in one domain, thereby enabling an electronic document to be accessed on another domain. In the preferred embodiment, as described herein, the terms “server” and “document processing device” are used to refer to an electronic device representative of the server portion of a client-server relationship, unless otherwise noted. As will be understood by those skilled in the art, the document processing device is suitably an image generating device. Preferably, the document processing device is a multifunctional peripheral device, capable of providing scanning, copying, facsimile, printing, document management, document storage, electronic mail, and other functions to a user. Thus, when reference hereinafter is made to a document processing device, the skilled artisan will appreciate that a server is equally capable of being employed in accordance with the present invention.

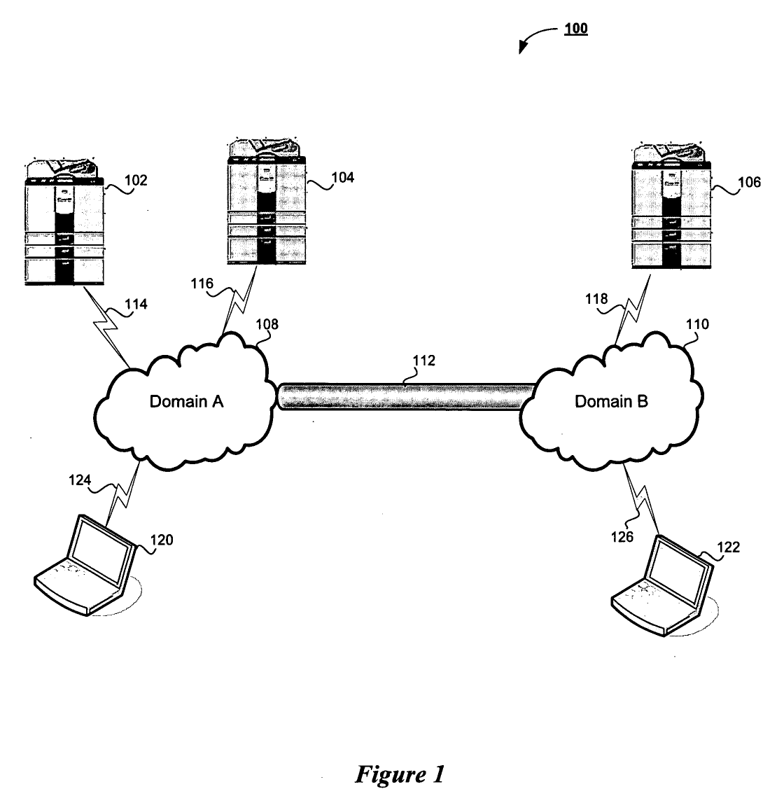

Referring now to FIG. 1, there is shown a block diagram illustrating a system 100 in accordance with the present invention. As illustrated in FIG. 1, the system 100 suitably includes one or more document processing devices, shown in FIG. 1 as the document processing device 102, the document processing device 104, and the document processing device 106. It will be appreciated by those skilled in the art the document processing devices 102-106 are advantageously represented in FIG. 1 as multifunction peripheral devices, suitably adapted to provide a variety of document processing services, such as, for example and without limitation, scanning, copying, facsimile, printing, and the like. Suitable commercially available document processing devices include, but are not limited to, the Toshiba e-Studio Series Controller. For purposes of explanation hereinafter, document processing devices 102 and 104 are located on domain A 108 and document processing device 106 is located on domain B 110. It will be appreciated by those skilled in the art that the domain suitably corresponds to a group of computers and devices on a network that are administered as a unit with common rules and procedures. It will further be appreciated by the skilled artisan that the domains 108 and 110 suitably communicate via a computer network 112. In one embodiment, domains 108 and 110 are local area networks in data communication via the Internet. Preferably, the computer network 112 is a wide area network, such as the Internet, however when implemented in a corporate setting, those skilled in the art will understand that he computer network 112 is capable of being a local area network, with the domains 108 and 110 operating thereon.

As shown in FIG. 1, the document processing devices 102 and 104 communicate with domain A 108 via communications links 114 and 116, respectively. As will be understood by those skilled in the art, the communication links 114 and 116 are any suitable channels for communication between electronic devices known in the art, including, without limitation, wired communications links, wireless communications links, such as WiMax, 802.11(x), infrared, and the like. Similarly, document processing device 106 is in data communication with domain B 110 via communications link 118. It will be appreciated by those skilled in the art that the communications link 118 is any suitable electronic communications channel known in the art, and, as referenced above with respect to communications links 114 and 116, includes, but is not limited to wired and wireless communications channels. It will be understood by those skilled in the art that the document processing devices 102-106 advantageously transmit and receive electronic document data via their respective communications links 114-118.

The system 100 of the present invention further includes one or more user devices, illustrated in FIG. 1 as the client device 120 of domain A 108 and the client device 122 of domain B 110. Preferably, the client devices 120 and 122 are any suitable electronic device known in the art capable of connecting to the respective domains 108 and 110. It will be understood by those skilled in the art that while client devices 120 and 122 are illustrated in FIG. 1 as laptop computers, any suitable computing device is equally capable of interfacing in accordance with the present invention. Suitable computing devices include, but are not limited to, desktop computers, a smart phone, a cellular-based personal electronic device, a web-based personal electronic device, and the like. The client devices 120 and 122 advantageously communicate with their respective domains 108 and 110 via suitable communications links 124 and 126. As will be understood by those skilled in the art, the communications links 124 and 126 are dependent upon the communications capabilities of the particular client device 120 and 122. Thus, as will be apparent to the skilled artisan, when client device 120 is a Bluetooth enabled personal data assistant, communications link 124 is suitably representative of a Bluetooth communications channel. When client device 122 is an 802.11(x) enabled laptop computer, communications link 126 is representative of an appropriate 802.11(x) communications channel. It will further be understood by those skilled in the art that suitable receivers, such as a Bluetooth receiving personal computer or an 802.11(x) access point are inherently required to send and receive communications between the devices 120 and 122 and the domains 108 and 110, and as such, should be inferred as included in the system 100, although not shown therein.

In accordance with the present invention, the system 100 advantageously functions to enable the inter-domain transmission of encrypted documents. In other words, the system 100 enables an encrypted document to be transmitted from the user device 120 to any of the document processing devices 102-106, and be decrypted by the receiving document processing device, irrespective of the domain of the receiving document processing device. In operation, the document processing device 106 of domain B 110 receives an encrypted electronic document from the client device 120 from domain A 108 containing header data. Preferably, the header data includes an identified file server associated with domain B 110. In the preferred embodiment, the file server is a document processing device containing user information and encryption/decryption information corresponding to the user which is trusted by the document processing device 106. The document processing device 106 then retrieves, from the trusted file server, decryption key information, which is then used to decrypt the received electronic document.

Further in accordance with the present invention, the document processing device 106 is suitably equipped with an associated data storage device (not shown). Those skilled in the art will appreciate that the associated data storage device is any mass storage device, known in the art, including, without limitation, dynamic memory, magnetic memory, optical memory, and the like, and suitable implementations of the data storage device include, but are not limited to, a separate server or personal computer in data communication with the document processing device 106, a removable storage medium, or, alternatively, an integrated hard disk drive, or the like. During operation of the present system 100, the document processing device 106, upon receipt of the encrypted electronic document, stores the document in the associated data storage device. In addition, depending upon the authorizations inherent to the document processing device 106 and the user authentication information, the received key information is also stored in the associated data storage device. The encrypted electronic document in the data storage device is then decrypted using the stored key information, resulting in a decrypted electronic document, which is then stored in the associated data storage device. The document processing device 106 commences the document processing operation associated with the transmitted electronic document on the decrypted electronic document stored in the data storage device.

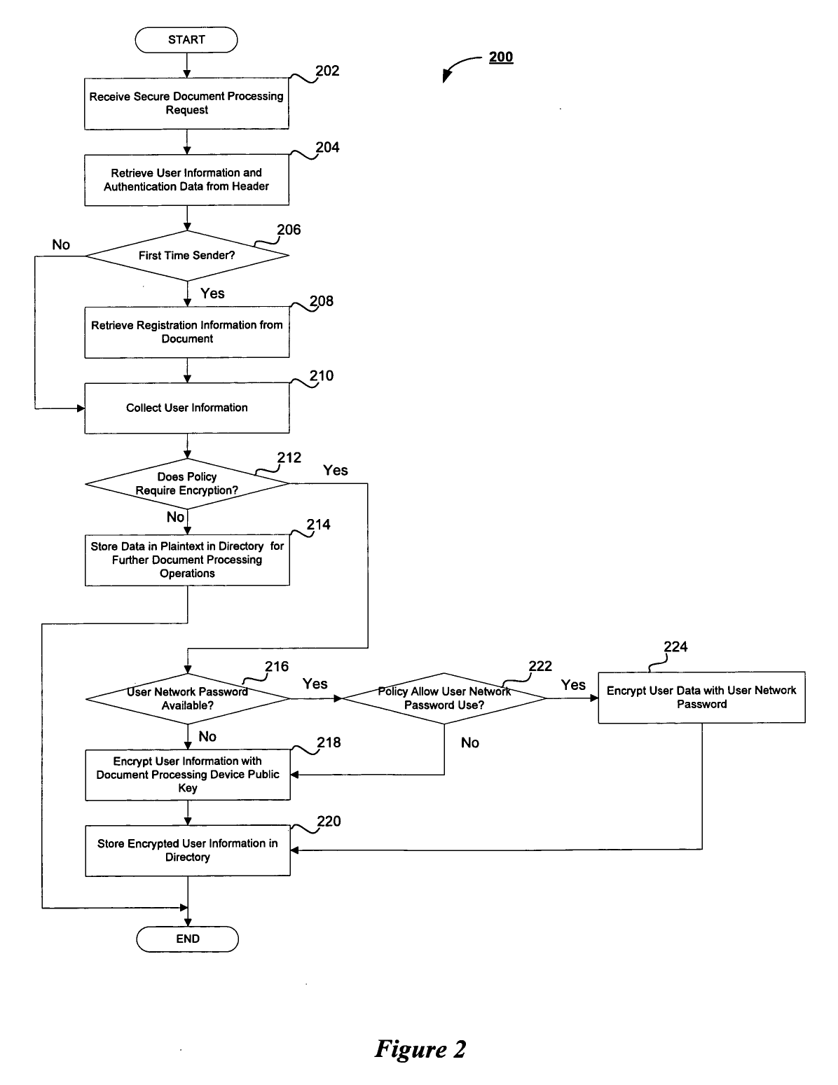

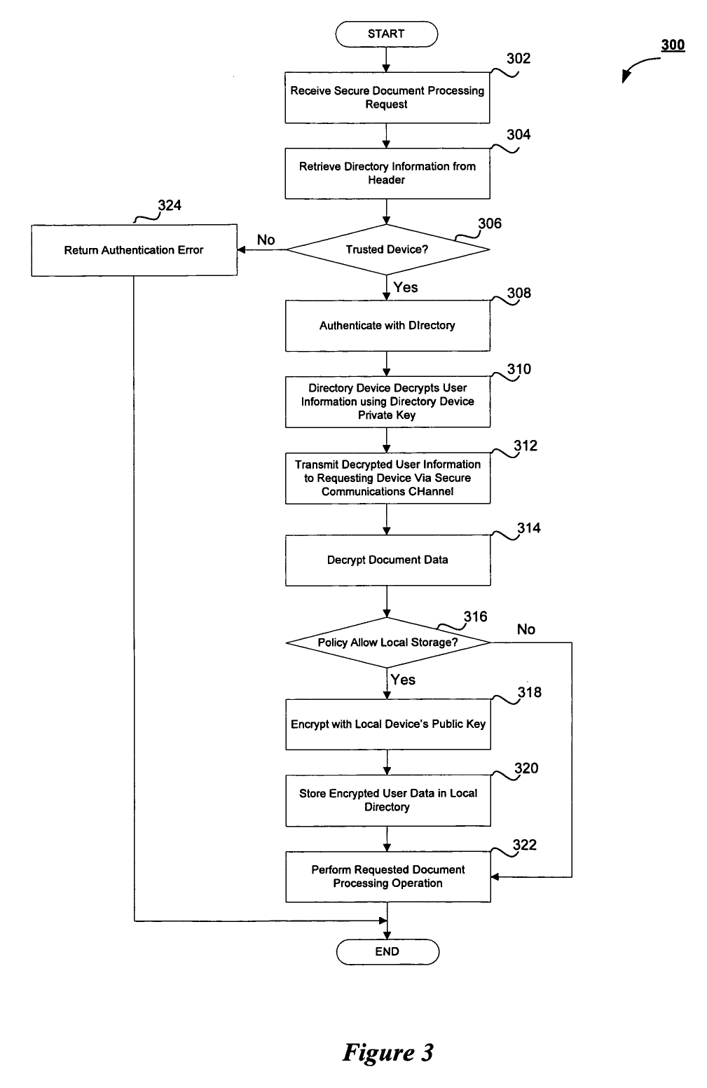

The system 100 of the present invention will better be understood in conjunction with the flowcharts of FIGS. 2 and 3, which detail the method of inter-domain transmission of an encrypted electronic document. Turning now to FIG. 2, there is shown a flowchart 200 illustrating a method of receiving and storing user authentication information for inter-domain transmission of an encrypted electronic document. Beginning at step 202, the document processing device 102 receives a secure document processing request consisting of an encrypted electronic document and a header, with the header containing user authentication information. In one embodiment, the header is encrypted using the public key of the intended document processing device 102. User registration and authentication information is then retrieved from the header of the encrypted electronic document at step 204. In the preferred embodiment, the header suitably includes the following: encrypted password shares (share1 and share2), an encrypted password key, the user public key, encrypted symmetric keys, encrypted user document processing preferences, other relevant public keys, and the like. It will be understood by those skilled in the art that the encrypted shares, keys, and preferences are suitably encrypted using the document processing device public key, or alternatively, the user's network password. The skilled artisan will appreciate that share1 and share2 suitably correspond to shares of a password key, which is used to encrypt the electronic document data. Suitable sharing schemes are well-known in the art and any such sharing scheme is capable of being employed by the present invention.

At step 206, a determination is made whether the user is a first time sender. In other words, a determination is made at step 206 whether or not the secure document processing request sent by the client device 120 is the first such secure document processing request received from the client device 120 by the document processing device 102. When the instant secure document processing request is the first such request received by the document processing device 102, flow proceeds to step 208, wherein registration information is retrieved from the header of the encrypted electronic document. In accordance with one aspect of the present invention, suitable registration information includes, but is not limited to, user identification, network password, user document processing preferences, and the like. The skilled artisan will appreciate that the header, referenced above, is capable of including such registration information, encrypted using the public key of the receiving document processing device 102.

When the registration process is complete, or when a negative determination is made at step 206, flow proceeds to step 210, wherein user authentication information is collected by the document processing device 102. In the preferred embodiment, the document processing device 102 first determines, from a policy set by a system administrator, what types of sender information is allowed to be collected and retained by the document processing device 102. In this embodiment, the document processing device 102 domain and the IP address information associated with the client device 120 are stored in the associated data storage device. The user secrets and authentication information are then collected in accordance with the sender information policy. A determination is then made at step 212 whether the sender information policy is set to require encryption of user information.

When the policy does not require encryption of user information, flow proceeds to step 214, wherein the user authentication information is stored in plain text format for use in further document processing operations performed by the document processing device 102. In the preferred embodiment, the user authentication information is stored in a personal information exchange syntax standard format, such as a Public-Key Cryptography Standards (PKCS) #12 format, and the like. It will be appreciated by those skilled in the art that any standard for a portable format for storing or transporting a user's private keys, certificates, miscellaneous secrets, and the like, is capable of being implemented in accordance with the present invention.

When the policy does require the encryption of user information, flow proceeds to step 216, wherein a determination is made whether the user's network password is available. As will be appreciated by those skilled in the art, the use of the user's network password key enables the secure transmission of an encrypted electronic document to the document processing device, the secure storage of the document on the device, and the output of the document upon entry at the document processing device of the network password by the user. When the user's network password is available, flow proceeds to step 222, wherein a determination is made whether or not the policy allows the use of a user network password for encryption of user authentication information. When such use is allowed, flow proceeds to step 224, wherein the user data is encrypted using the user network password. The encrypted user information is then stored at step 220 in the document processing device 102 directory. It will be appreciated by those skilled in the art that the storage is capable of being assigned to a trusted file server on the domain A 108, in addition to the storage on the document processing device 102 itself. In the preferred embodiment, the user authentication information is stored in a personal information exchange syntax standard format, such as a PKCS#12 format, and the like. It will be appreciated by those skilled in the art that any standard for a portable format for storing or transporting a user's private keys, certificates, miscellaneous secrets, and the like, is capable of being implemented in accordance with the present invention.

Returning to step 222, when the sender information policy does not allow the use of a user network password for encryption purposes, flow proceeds to step 218, wherein the user authentication information is encrypted using the public key of the document processing device 102. The encrypted user authentication information is then stored at step 220 in an enveloped/encrypted format, preferably in the PKCS#12 personal information exchange syntax standard format, or other similar portable secure format. Referring back to step 216, when it is determined that the user's network password is not available for use in encrypting user authentication information, flow proceeds to step 218, wherein the document processing device 102 public key is used to encrypt the user authentication information. The encrypted user information, preferably in the PKCS#12 format, is then stored in an associated data storage device associated with the document processing device 102.

Having thus described the process whereby user authentication information is retrieved and stored when the sending device 120 and the receiving device 102 reside on the same domain, discussion now turns to FIG. 3. In FIG. 3, the flowchart 300 illustrates the method wherein the sending device 120 and the receiving device 106 reside on different domains, domain A 108 and domain B 110, respectively. Beginning at step 302, the document processing device 106 receives a secure document processing request from the client device 102 containing encrypted electronic document data and header. At step 304, the document processing device 106 retrieves, from the header accompanying the received encrypted electronic document, directory information corresponding to the directory containing user authentication information. Such directory information is advantageously capable of directing retrieval to a file server, document processing device, or other network device, which contains user authentication information. Preferably, the directory information is in an unencrypted format, enabling any receiving device to determine where to seek user authentication information, if available. Stated another way, the header directs the receiving document processing device 106 to a trusted file server.

At step 306, a determination is made as to whether the designated file server represents a trusted source to the receiving document processing device 106. The means through which a source device becomes “trusted” by a receiving device are well-known in the art and any such means are capable of being implemented herein, without departing from the scope of the present invention. It will be appreciated by those skilled in the art that the file server, in keeping with the example of FIG. 2, is advantageously one of the other document processing devices 102 and 104, located in the system 100. As explained above, the document processing device 102 contains stored user authentication information and thus for purposes of explanation only, the document processing device 102 and the file server of FIG. 3 are used interchangeably, however the skilled artisan will appreciate that a file server, located on either domain, is equally capable of fulfilling the role of the document processing device 102 as discussed herein with respect to the method of FIG. 3. Preferably, the user associated with the secure document processing request inputs at the document processing device 106 a user identification and password to authenticate the user prior to establishment of the trusted communications, described below. When it is determined at step 306 that the designated file server (document processing device 102) is not a trusted source, flow proceeds to step 324, wherein an authentication error is returned to the client device 120 and operations with respect to the document processing device 106 terminate.

When it is determined at step 306 that the designated file server 102 is a trusted source for the receiving document processing device 106, flow proceeds to step 308, wherein the document processing device 106 authenticates with the designated file server 102. It will be understood by those skilled in the art that the trust relationship extends in both directions, thus prior to assisting the receiving document processing device 106 with user authentication information, the file server 102 must authenticate the document processing device 106. Thus, during the establishment of the trust relationship, the file server 102 and the document processing device 106 are capable of sharing trust related policies, such as, for example and without limitation, policies embedded in cross-certificates and the like. It will further be appreciated by those skilled in the art that as the client device 120 and the document processing device 106 are on separate domains, it is unlikely that the client device 120 had the document processing device 106 public key at the time the document was transmitted. Thus, the header was encrypted with a public key corresponding to the file server 102. Following the authentication of the directory, e.g., the file server 102, flow proceeds to step 310, wherein the file server 102 decrypts the header containing user authentication information using the file server 102 public key.

The decrypted header is then transmitted back to the document processing device 106 via an SSL encrypted channel at step 312. The skilled artisan will appreciate that the present invention is capable of using any equally secure encryption channel known in the art to securely communicate the user authentication information of the decrypted header from the file server 102 to the document processing device 106. At step 314, the document processing device 106 uses the user authentication information to decrypt the encrypted electronic document. The skilled artisan will appreciate that such decryption is capable of requiring the reconstruction of a symmetric password key from two or more shares contained in the header, and the like. Once decryption has been completed, flow proceeds to step 316, wherein a determination is made whether the sender information policy, corresponding to the client device 120 domain A 108, allows local storage of user authentication information, i.e., storing the authentication information in domain B 110 at the document processing device 106. When no such storage is authorized, flow proceeds to step 322, wherein the decrypted document is processed by the document processing device 106 in accordance with received document processing request.

Returning to step 316, when the sender information policy of domain A 108 allows for the local retention of user authentication information by the document processing device 106, flow proceeds to step 318, wherein the user authentication is encrypted using the document processing device 106 public key. The encrypted user authentication information is then stored in a data storage associated with the local document processing device 106 at step 320. Flow then progresses to step 322, wherein the decrypted electronic document is output in accordance with the received secure document processing request. The skilled artisan will appreciate that such output is capable of being contingent upon the input of a user designated password at the document processing device 106, or the like. In the preferred embodiment, the user authentication information is stored in a personal information exchange syntax standard format, such as a PKCS#12 format, and the like. It will be appreciated by those skilled in the art that any standard for a portable format for storing or transporting a user's private keys, certificates, miscellaneous secrets, and the like, is capable of being implemented in accordance with the present invention.

The invention extends to computer programs in the form of source code, object code, code intermediate sources and object code (such as in a partially compiled form), or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed:

1. A system for secure inter-domain document transmission comprising:
means adapted for receiving into a target domain from a source domain, an encrypted electronic document inclusive of header data, the header data including data representative of an identified file server associated with the source domain;
means adapted for retrieving, from the identified file server, key data; and
means adapted for commencing a decryption of the electronic document with the key data.

2. The system for secure inter-domain document transmission of claim 1, further comprising:
means adapted for receiving the encrypted electronic document into a data storage associated with a document processor;
means adapted for receiving the key data into the data storage;
means adapted for completing a decryption of the electronic document;
means adapted for storing a decrypted electronic document in the data storage; and
means adapted for commencing a selected document processing operation on the decrypted electronic document.

3. The system for secure inter-domain document transmission of claim 2, wherein the header data includes data representative of a plurality of identified file servers in a plurality of domains.

4. The system for secure inter-domain document transmission of claim 3, wherein the header data further includes data representative of user authentication information.

5. The system for secure inter-domain document transmission of claim 4, wherein the user authentication information includes at least one of the group consisting of a user identification, a user network password, a user public key, an encrypted user private key, an encrypted symmetric password key, and encrypted user document processing preferences.

6. The system for secure inter-domain document transmission of claim 5, further comprising:
means adapted for encrypting the user authentication information using a public key associated with the receiving document processor; and
means adapted for storing, in the data storage associated with the document processor, the encrypted user authentication information.

7. A method for secure inter-domain document transmission comprising the steps of:
receiving into a target domain from a source domain, an encrypted electronic document inclusive of header data, the header data including data representative of an identified file server associated with the source domain;
retrieving, from the identified file server, key data; and
commencing a decryption of the electronic document with the key data.

8. The method for secure inter-domain document transmission of claim 7, further comprising the steps of:
receiving the encrypted electronic document into a data storage associated with a document processor;
receiving the key data into the data storage;
completing a decryption of the electronic document;
storing a decrypted electronic document in the data storage; and
commencing a selected document processing operation on the decrypted electronic document.

9. The method for secure inter-domain document transmission of claim 8, wherein the header data includes data representative of a plurality of identified file servers in a plurality of domains.

10. The method for secure inter-domain document transmission of claim 9, wherein the header data further includes data representative of user authentication information.

11. The method for secure inter-domain document transmission of claim 10, wherein the user authentication information includes at least one of the group consisting of a user identification, a user network password, a user public key, an encrypted user private key, an encrypted symmetric password key, and plurality of encrypted user document processing preferences.

12. The method for secure inter-domain document transmission of claim 11, further comprising the steps of:
encrypting the user authentication information using a public key associated with the receiving document processor; and
storing, in the data storage associated with the document processor, the encrypted user authentication information.

13. A computer-readable medium of instructions with computer-readable instructions stored thereon for secure inter-domain document transmission comprising:
instructions for receiving into a target domain from a source domain, an encrypted electronic document inclusive of header data, the header data including data representative of an identified file server associated with the source domain;
instructions for retrieving, from the identified file server, key data; and
instructions for commencing a decryption of the electronic document with the key data.

14. The computer-readable medium of instructions with computer-readable instructions stored thereon for secure inter-domain document transmission of claim 13, further comprising:
instructions for receiving the encrypted electronic document into a data storage associated with a document processor;
instructions for receiving the key data into the data storage;
instructions for completing a decryption of the electronic document;
instructions for storing a decrypted electronic document in the data storage; and
instructions for commencing a selected document processing operation on the decrypted electronic document.

15. The computer-readable medium of instructions with computer-readable instructions stored thereon for secure inter-domain document transmission of claim 14, wherein the header data includes data representative of a plurality of identified file servers in a plurality of domains.

16. The computer-readable medium of instructions with computer-readable instructions stored thereon for secure inter-domain document transmission of claim 15, wherein the header data further includes data representative of user authentication information.

17. The computer-readable medium of instructions with computer-readable instructions stored thereon for secure inter-domain document transmission of claim 16, wherein the user authentication information includes at least one of the group consisting of a user identification, a user network password, a user public key, an encrypted user private key, an encrypted symmetric password key, and encrypted user document processing preferences.

18. The computer-readable medium of instructions with computer-readable instructions stored thereon for secure inter-domain document transmission of claim 17, further comprising:
instructions for encrypting the user authentication information using a public key associated with the receiving document processor; and
instructions for storing, in the data storage associated with the document processor, the encrypted user authentication information.
